(19) United States
(12) Patent Application Publication
(10) Pub. No.: US 2024/0198566 A1
(43) Pub. Date: Jun. 20, 2024

(54) DISPLAY UNIT OF INJECTION MOLDING MACHINE, CONTROL DEVICE OF INJECTION MOLDING MACHINE, AND INJECTION MOLDING MACHINE

(71) Applicant: SUMITOMO HEAVY INDUSTRIES, LTD., Tokyo (JP)

(72) Inventors: Daigo HOTTA, Chiba-shi (JP); Takasue YAMAGUCHI, Chiba-shi (JP); Takuya MIZUNASHI, Chiba-shi (JP)

(21) Appl. No.: 18/525,743

(22) Filed: Nov. 30, 2023

(30) Foreign Application Priority Data
Dec. 19, 2022 (JP) 2022-202187

(51) Int. Cl. B29C 45/17; B29C 45/03; B29C 45/47; B29C 45/62; B29C 45/74; B29C 45/77

(52) U.S. Cl. CPC B29C 45/1774; B29C 45/03; B29C 45/47; B29C 45/62; B29C 45/74; B29C 45/77; B29C 2045/7606

(57) ABSTRACT

A display unit of an injection molding machine, which includes an injection member provided in a cylinder heating a molding material and an injection drive source causing the injection member to advance to fill an inside of a mold unit with the molding material, displays a screen including a selection part, which receives a selection of whether to perform a retreat speed control to control an actual speed value of the injection member to a first set value or a retreat speed limitation to limit the actual speed value of the injection member to a second set value or less during a retreat of the injection member, in an injection process for controlling a speed of the injection member or a pressure acting on the molding material from the injection member.

### CROSS-REFERENCE TO RELATED APPLICATIONS

This application claims priority to Japanese Patent Application No. 2022-202187, filed on Dec. 19, 2022, which is incorporated by reference herein in its entirety.

### BACKGROUND

### Technical Field

Certain embodiments of the present invention relate to a display unit of an injection molding machine, a control device of an injection molding machine, and an injection molding machine.

### Description of Related Art

An injection molding machine includes an injection member that is provided in a cylinder heating a molding material, an injection drive source that causes the injection member to advance to fill an inside of a mold unit with the molding material, and a control device that controls the injection drive source (for example, see the related art). The injection member is, for example, a screw. The screw is disposed in the cylinder to be rotatable and to be capable of advancing and retreating.

The control device performs a filling process and a holding pressure process in this order. The filling process is a process for filling the inside of the mold unit with the molding material by controlling the injection drive source such that an actual value of a movement speed of the injection member reaches a set value. The holding pressure process is a process for replenishing a shortage of the molding material, which is caused by cooling shrinkage in the mold unit, by controlling the injection drive source such that an actual value of a pressure acting on the molding material from the injection member reaches a set pressure value.

Switching of the filling process to the holding pressure process is also referred to as V/P switching. In a case where the actual pressure value is larger than the set pressure value immediately after the V/P switching, the injection member is caused to retreat so that the actual pressure value is reduced. The related art discloses that an adverse effect on the quality of a molding product caused in a case where the injection member retreats at a high speed immediately after the V/P switching can be eliminated in a case where a limit value for the retreat speed of the injection member is provided in the holding pressure process.

### SUMMARY

A display unit according to an aspect of the present invention is a display unit of an injection molding machine including an injection member that is provided in a cylinder heating a molding material and an injection drive source that causes the injection member to advance to fill an inside of a mold unit with the molding material. The display unit displays a screen including a selection part, which receives a selection of whether to perform a retreat speed control to control an actual speed value of the injection member to a first set value or a retreat speed limitation to limit the actual speed value of the injection member to a second set value or less during a retreat of the injection member, in an injection process for controlling a speed of the injection member or a pressure acting on the molding material from the injection member.

### BRIEF DESCRIPTION OF THE DRAWINGS

FIG. 1 is a diagram showing a state of an injection molding machine according to an embodiment at a time of completion of mold opening.

FIG. 2 is a diagram showing a state of the injection molding machine according to the embodiment at a time of mold clamping.

FIG. 3 is a diagram showing an example of components of a control device as functional blocks.

FIG. 4 is a diagram showing an example of processes of a molding cycle.

FIG. 5 is a diagram showing an example of an injection control unit.

FIG. 6 is a diagram showing an example of a speed command correction part.

FIG. 7A is a diagram showing an example of a screen in a case where a retreat speed control is selected, and FIG. 7B is a diagram showing an example of a screen in a case where a retreat speed limitation is selected.

FIG. 8 is a diagram showing an example of changes in screw speed, pressure, and screw position with time in a case where a retreat speed control is selected.

### DETAILED DESCRIPTION

A cavity space formed in the mold unit is filled with the molding material and the molding material is solidified, so that a molding product is obtained. In the related art, a retreat speed limitation for limiting the actual speed value of the injection member to a value equal to or smaller than the set value is performed during the retreat of the injection member to eliminate an adverse effect on the quality of a molding product.

However, another control may be required instead of the retreat speed limitation depending on a molding product. For example, in a case where a thickness of a molding product is small, a retreat speed control for controlling the actual speed value of the injection member to the set value is required during the retreat of the injection member.

In a case where the thickness of a molding product is small, an advance speed of the injection member is set high in the filling process so that a flow of the molding material does not stop in the filling process. In this case, a high resin pressure is generated at an inlet of the cavity space.

In a case where the advance speed of the injection member is set high in the filling process as described above, it is required to reduce a resin pressure by performing the retreat speed control so that a molding product does not warp due to uneven distribution of residual stress.

It is desirable to provide a technique that can switch setting of an injection process depending on a molding product.

Embodiments of the present invention will be described below with reference to the drawings. The same or corresponding components will be denoted in the respective drawings by the same reference numerals, and the description thereof will be omitted.

### Injection Molding Machine

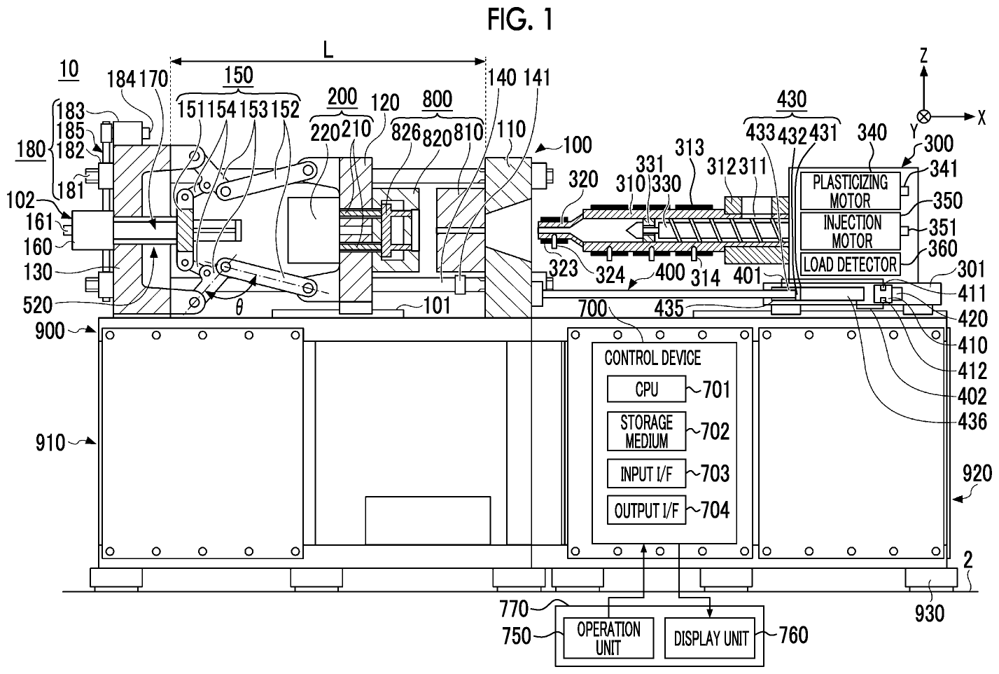

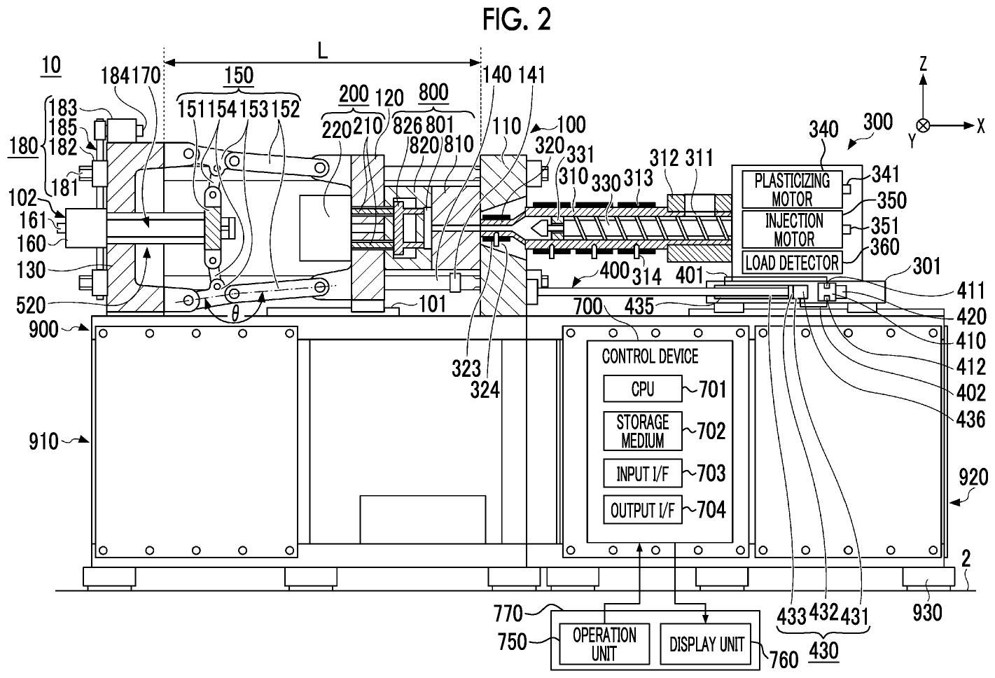

FIG. 1 is a diagram showing a state of an injection molding machine according to an embodiment at a time of completion of mold opening. FIG. 2 is a diagram showing a state of the injection molding machine according to the embodiment at a time of mold clamping. In this specification, an X-axis direction, a Y-axis direction, and a Z-axis direction are directions perpendicular to each other. The X-axis direction and the Y-axis direction indicate horizontal directions, and the Z-axis direction indicates a vertical direction. In a case where a mold clamping unit 100 is of a horizontal type, the X-axis direction is a mold opening/closing direction and the Y-axis direction is a width direction of an injection molding machine 10. A negative side in the Y-axis direction is referred to as an operation side, and a positive side in the Y-axis direction is referred to as a counter-operation side.

As shown in FIGS. 1 and 2, the injection molding machine 10 includes a mold clamping unit 100 that opens and closes a mold unit 800, an ejector unit 200 that ejects molding products molded by the mold unit 800, an injection unit 300 that injects a molding material into the mold unit 800, a moving unit 400 that causes the injection unit 300 to advance and retreat with respect to the mold unit 800, a control device 700 that controls the respective components of the injection molding machine 10, and a frame 900 that supports the respective components of the injection molding machine 10. The frame 900 includes a mold clamping unit frame 910 that supports the mold clamping unit 100, and an injection unit frame 920 that supports the injection unit 300. The mold clamping unit frame 910 and the injection unit frame 920 are installed on a floor 2 via leveling adjusters 930, respectively. The control device 700 is disposed in an internal space of the injection unit frame 920. The respective components of the injection molding machine 10 will be described below.

### Mold Clamping Unit

In the description of the mold clamping unit 100, a moving direction of a movable platen 120 in a case where a mold is to be closed (for example, an X-axis positive direction) will correspond to a front, and a moving direction of the movable platen 120 in a case where the mold is to be opened (for example, an X-axis negative direction) will correspond to a rear.

The mold clamping unit 100 performs mold closing, pressurization, mold clamping, depressurization, and mold opening of the mold unit 800. The mold unit 800 includes a stationary mold 810 and a movable mold 820.

The mold clamping unit 100 is of, for example, a horizontal type, and the mold opening/closing direction of the mold clamping unit 100 is a horizontal direction. The mold clamping unit 100 includes a stationary platen 110 to which the stationary mold 810 is attached, the movable platen 120 to which the movable mold 820 is attached, and a moving mechanism 102 that moves the movable platen 120 with respect to the stationary platen 110 in the mold opening/closing direction.

The stationary platen 110 is fixed to the mold clamping unit frame 910. The stationary mold 810 is attached to a surface of the stationary platen 110 facing the movable platen 120.

The movable platen 120 is disposed to be movable with respect to the mold clamping unit frame 910 in the mold opening/closing direction. Guides 101 that guide the movable platen 120 are laid on the mold clamping unit frame 910. The movable mold 820 is attached to a surface of the movable platen 120 facing the stationary platen 110.

The moving mechanism 102 causes the movable platen 120 to advance and retreat with respect to the stationary platen 110 to perform mold closing, pressurization, mold clamping, depressurization, and mold opening of the mold unit 800. The moving mechanism 102 includes a toggle support 130 that is disposed with an interval between the stationary platen 110 and itself, tie bars 140 that connect the stationary platen 110 to the toggle support 130, a toggle mechanism 150 that moves the movable platen 120 with respect to the toggle support 130 in the mold opening/closing direction, a mold clamping motor 160 that operates the toggle mechanism 150, a motion conversion mechanism 170 that converts a rotary motion of the mold clamping motor 160 into a linear motion, and a mold space adjustment mechanism 180 that adjusts an interval between the stationary platen 110 and the toggle support 130.

The toggle support 130 is disposed with an interval between the stationary platen 110 and itself, and is placed on the mold clamping unit frame 910 to be movable in the mold opening/closing direction. The toggle support 130 may be disposed to be movable along guides laid on the mold clamping unit frame 910. The guides for the toggle support 130 may be common to the guides 101 for the movable platen 120.

In the present embodiment, the stationary platen 110 is fixed to the mold clamping unit frame 910, and the toggle support 130 is disposed to be movable with respect to the mold clamping unit frame 910 in the mold opening/closing direction. However, the toggle support 130 may be fixed to the mold clamping unit frame 910, and the stationary platen 110 may be disposed to be movable with respect to the mold clamping unit frame 910 in the mold opening/closing direction.

The tie bars 140 connect the stationary platen 110 to the toggle support 130 with an interval L between the stationary platen 110 and the toggle support 130 in the mold opening/closing direction. A plurality of (for example, four) tie bars 140 may be used. The plurality of tie bars 140 are disposed parallel to the mold opening/closing direction and extend depending on a mold clamping force. At least one tie bar 140 may be provided with a tie bar strain detector 141 that measures a strain of the tie bar 140. The tie bar strain detector 141 sends a signal indicating a detection result thereof to the control device 700. The detection result of the tie bar strain detector 141 may be used for the measurement of a mold clamping force, and the like.

The tie bar strain detector 141 is used in the present embodiment as a mold clamping force detector for measuring a mold clamping force, but the present invention is not limited thereto. The mold clamping force detector is not limited to a strain gauge type and may be a piezoelectric type, a capacitive type, a hydraulic type, an electromagnetic type, or the like. A position where the mold clamping force detector is attached is also not limited to the tie bar 140.

The toggle mechanism 150 is disposed between the movable platen 120 and the toggle support 130, and moves the movable platen 120 with respect to the toggle support 130 in the mold opening/closing direction. The toggle mechanism 150 includes a crosshead 151 that moves in the mold opening/closing direction and a pair of link groups that is bent and stretched depending on the movement of the crosshead 151. Each of the pair of link groups includes a first link 152 and a second link 153 that are bendably and stretchably connected to each other by a pin or the like. The first link 152 is oscillatingly attached to the movable platen 120 by a pin or the like. The second link 153 is oscillatingly attached to the toggle support 130 by a pin or the like. The second link 153 is attached to the crosshead 151 via a third link 154. In a case where the crosshead 151 is caused to advance and retreat with respect to the toggle support 130, the first and second links 152 and 153 are bent and stretched, and the movable platen 120 advances and retreats with respect to the toggle support 130.

The configuration of the toggle mechanism 150 is not limited to the configuration shown in FIGS. 1 and 2. For example, the number of nodes of each link group is five in FIGS. 1 and 2 but may be four. One end portion of the third link 154 may be connected to the node between the first and second links 152 and 153.

The mold clamping motor 160 is attached to the toggle support 130 and operates the toggle mechanism 150. The mold clamping motor 160 causes the crosshead 151 to advance and retreat with respect to the toggle support 130, so that the first and second links 152 and 153 are bent and stretched to cause the movable platen 120 to advance and retreat with respect to the toggle support 130. The mold clamping motor 160 is directly connected to the motion conversion mechanism 170, but may be connected to the motion conversion mechanism 170 via a belt, pulleys, and the like.

The motion conversion mechanism 170 converts a rotary motion of the mold clamping motor 160 into a linear motion of the crosshead 151. The motion conversion mechanism 170 includes a screw shaft and a screw nut that is screwed to the screw shaft. Balls or rollers may be interposed between the screw shaft and the screw nut.

The mold clamping unit 100 performs a mold closing process, a pressurization process, a mold clamping process, a depressurization process, a mold opening process, and the like under the control of the control device 700.

In the mold closing process, the mold clamping motor 160 is driven to cause the crosshead 151 to advance up to a mold closing completion position at a set movement speed, so that the movable platen 120 is caused to advance and causes the movable mold 820 to touch the stationary mold 810. The position and the movement speed of the crosshead 151 are measured using, for example, a mold clamping motor encoder 161 or the like. The mold clamping motor encoder 161 measures rotation of the mold clamping motor 160, and sends a signal indicating a detection result thereof to the control device 700.

A crosshead position detector for measuring the position of the crosshead 151 and a crosshead movement speed detector for measuring the movement speed of the crosshead 151 are not limited to the mold clamping motor encoder 161, and general detectors can be used. Further, a movable platen position detector for measuring the position of the movable platen 120 and a movable platen movement speed detector for measuring the movement speed of the movable platen 120 are not limited to the mold clamping motor encoder 161, and general detectors can be used.

In the pressurization process, the mold clamping motor 160 is further driven to cause the crosshead 151 to further advance from the mold closing completion position up to a mold clamping position and to generate a mold clamping force.

In the mold clamping process, the mold clamping motor 160 is driven to maintain the position of the crosshead 151 at the mold clamping position. In the mold clamping process, the mold clamping force generated in the pressurization process is maintained. In the mold clamping process, cavity spaces 801 (see FIG. 2) are formed between the movable mold 820 and the stationary mold 810, and the injection unit 300 fills the cavity spaces 801 with liquid molding material. Molding products are obtained in a case where the molding material filling the cavity spaces is solidified.

One cavity space 801 may be provided, or a plurality of cavity spaces 801 may be provided. In the latter case, a plurality of molding products are obtained at the same time. An insert material may be disposed in a part of each cavity space 801, and the other part of each cavity space 801 may be filled with a molding material. Molding products in which the insert material and the molding material are integrated with each other are obtained.

In the depressurization process, the mold clamping motor 160 is driven to cause the crosshead 151 to retreat from the mold clamping position up to a mold opening start position, so that the movable platen 120 is caused to retreat to reduce the mold clamping force. The mold opening start position and the mold closing completion position may be the same position.

In the mold opening process, the mold clamping motor 160 is driven to cause the crosshead 151 to retreat from the mold opening start position up to a mold opening completion position at a set movement speed, so that the movable platen 120 is caused to retreat and causes the movable mold 820 to be separated from the stationary mold 810. After that, the ejector unit 200 ejects the molding products from the movable mold 820.

Set conditions in the mold closing process, the pressurization process, and the mold clamping process are collectively set as a series of set conditions. For example, movement speeds and positions (including a mold closing start position, a movement speed switching position, a mold closing completion position, and a mold clamping position) of the crosshead 151 and mold clamping forces in the mold closing process and the pressurization process are collectively set as a series of set conditions. The mold closing start position, the movement speed switching position, the mold closing completion position, and the mold clamping position are arranged in this order from a rear side toward the front, and indicate starting points and end points of sections in which the movement speeds are set. The movement speed is set for each section. One movement speed switching position may be set, or a plurality of movement speed switching positions may be set. The movement speed switching position may not be set. Only one of the mold clamping position and the mold clamping force may be set.

Set conditions in the depressurization process and the mold opening process are also collectively set in the same manner. For example, movement speeds and positions (including the mold opening start position, the movement speed switching position, and the mold opening completion position) of the crosshead 151 in the depressurization process and the mold opening process are collectively set as a series of set conditions. The mold opening start position, the movement speed switching position, and the mold opening completion position are arranged in this order from a front side toward the rear, and indicate starting points and end points of sections in which the movement speeds are set. The movement speed is set for each section. One movement speed switching position may be set, or a plurality of movement speed switching positions may be set. The movement speed switching position may not be set. The mold opening start position and the mold closing completion position may be the same position. Further, the mold opening completion position and the mold closing start position may be the same position.

The movement speeds, the positions, and the like of the movable platen 120 may be set instead of the movement speeds, the positions, and the like of the crosshead 151. Further, a mold clamping force may be set instead of the position (for example, the mold clamping position) of the crosshead or the position of the movable platen.

The toggle mechanism 150 amplifies the driving force of the mold clamping motor 160 and transmits the amplified driving force to the movable platen 120. The amplification factor of the toggle mechanism 150 is also referred to as a toggle factor. The toggle factor is changed depending on an angle θ between the first and second links 152 and 153 (hereinafter, also referred to as a “link angle θ”). The link angle θ is obtained from the position of the crosshead 151. In a case where the link angle θ is 180°, the toggle factor is at its maximum.

In a case where a thickness of the mold unit 800 is changed due to replacement of the mold unit 800, a change in a temperature of the mold unit 800, or the like, a mold space is adjusted such that a predetermined mold clamping force is obtained during mold clamping. In the adjustment of a mold space, the interval L between the stationary platen 110 and the toggle support 130 is adjusted such that the link angle θ of the toggle mechanism 150 is a predetermined angle at a time of mold touch when, for example, the movable mold 820 touches the stationary mold 810.

The mold clamping unit 100 includes a mold space adjustment mechanism 180. The mold space adjustment mechanism 180 adjusts the interval L between the stationary platen 110 and the toggle support 130 to adjust a mold space. A timing when a mold space is adjusted is, for example, between the end of a molding cycle and the start of the next molding cycle. The mold space adjustment mechanism 180 includes, for example, screw shafts 181 that are formed at rear end portions of the tie bars 140, screw nuts 182 that are rotatably held by the toggle support 130 not to be capable of advancing and retreating, and a mold space adjustment motor 183 that rotates the screw nuts 182 screwed to the screw shafts 181.

The screw shaft 181 and the screw nut 182 are provided for each tie bar 140. A rotational driving force of the mold space adjustment motor 183 may be transmitted to a plurality of screw nuts 182 via a rotational driving force transmission unit 185. The plurality of screw nuts 182 can be rotated in synchronization. It is also possible to individually rotate the plurality of screw nuts 182 by changing a transmission channel of the rotational driving force transmission unit 185.

The rotational driving force transmission unit 185 includes, for example, gears and the like. In this case, a driven gear is formed on an outer periphery of each screw nut 182, a driving gear is attached to an output shaft of the mold space adjustment motor 183, and an intermediate gear, which meshes with a plurality of driven gears and the driving gear, is rotatably held at a central portion of the toggle support 130. The rotational driving force transmission unit 185 may include a belt, pulleys, and the like instead of the gears.

The operation of the mold space adjustment mechanism 180 is controlled by the control device 700. The control device 700 drives the mold space adjustment motor 183 to rotate the screw nuts 182. As a result, the position of the toggle support 130 with respect to the tie bars 140 is adjusted, so that the interval L between the stationary platen 110 and the toggle support 130 is adjusted. A plurality of mold space adjustment mechanisms may be used in combination.

The interval L is measured using a mold space adjustment motor encoder 184. The mold space adjustment motor encoder 184 measures an amount of rotation and a rotation direction of the mold space adjustment motor 183, and sends signals indicating detection results thereof to the control device 700. The detection results of the mold space adjustment motor encoder 184 are used for the monitoring and control of the position of the toggle support 130 and the interval L. A toggle support position detector for measuring the position of the toggle support 130 and an interval detector for measuring the interval L are not limited to the mold space adjustment motor encoder 184, and general detectors can be used.

The mold clamping unit 100 may include a mold temperature controller that adjusts the temperature of the mold unit 800. The mold unit 800 includes a flow channel for a temperature control medium therein. The mold temperature controller adjusts a temperature of a temperature control medium, which is supplied to the flow channel of the mold unit 800, to adjust the temperature of the mold unit 800.

The mold clamping unit 100 of the present embodiment is of a horizontal type in which a mold opening/closing direction is a horizontal direction, but may be of a vertical type in which a mold opening/closing direction is a vertical direction.

The mold clamping unit 100 of the present embodiment includes the mold clamping motor 160 as a drive unit, but may include a hydraulic cylinder instead of the mold clamping motor 160. Further, the mold clamping unit 100 may include a linear motor for opening and closing the mold and may include an electromagnet for clamping the mold.

### Ejector Unit

In the description of the ejector unit 200, as in the description of the mold clamping unit 100, the moving direction of the movable platen 120 in a case where the mold is to be closed (for example, the X-axis positive direction) will correspond to a front, and the moving direction of the movable platen 120 in a case where the mold is to be opened (for example, the X-axis negative direction) will correspond to a rear.

The ejector unit 200 is attached to the movable platen 120, and advances and retreats together with the movable platen 120. The ejector unit 200 includes ejector rods 210 that eject the molding products from the mold unit 800, and a drive mechanism 220 that moves the ejector rods 210 in the moving direction of the movable platen 120 (X-axis direction).

The ejector rods 210 are disposed in through-holes of the movable platen 120 to be capable of advancing and retreating. Front end portions of the ejector rods 210 are in contact with an ejector plate 826 of the movable mold 820. The front end portions of the ejector rods 210 may be connected to or may not be connected to the ejector plate 826.

The drive mechanism 220 includes, for example, an ejector motor and a motion conversion mechanism that converts a rotary motion of the ejector motor into a linear motion of the ejector rods 210. The motion conversion mechanism includes a screw shaft and a screw nut that is screwed to the screw shaft. Balls or rollers may be interposed between the screw shaft and the screw nut.

The ejector unit 200 performs an ejection process under the control of the control device 700. In the ejection process, the ejector rods 210 are caused to advance up to an ejection position from a standby position at a set movement speed, so that the ejector plate 826 is caused to advance to eject the molding products. After that, the ejector motor is driven to cause the ejector rods 210 to retreat at a set movement speed and to cause the ejector plate 826 to retreat up to the original standby position.

The position and the movement speed of each ejector rod 210 are measured using, for example, an ejector motor encoder. The ejector motor encoder measures rotation of the ejector motor, and sends a signal indicating a detection result thereof to the control device 700. An ejector rod position detector for measuring the position of each ejector rod 210 and an ejector rod movement speed detector for measuring the movement speed of each ejector rod 210 are not limited to the ejector motor encoder, and general detectors can be used.

### Injection Unit

In the description of the injection unit 300, unlike in the description of the mold clamping unit 100 and the description of the ejector unit 200, a moving direction of a screw 330 during filling (for example, the X-axis negative direction) will correspond to a front, and a moving direction of the screw 330 during plasticizing (for example, the X-axis positive direction) will correspond to a rear.

The injection unit 300 is installed on a slide base 301, and the slide base 301 is disposed to be capable of advancing and retreating with respect to the injection unit frame 920. The injection unit 300 is disposed to be capable of advancing and retreating with respect to the mold unit 800. The injection unit 300 touches the mold unit 800, and fills the cavity spaces 801 formed in the mold unit 800 with a molding material. The injection unit 300 includes, for example, a cylinder 310 that heats the molding material, a nozzle 320 that is provided at a front end portion of the cylinder 310, the screw 330 that is disposed in the cylinder 310 to be capable of advancing and retreating and to be rotatable, a plasticizing motor 340 that rotates the screw 330, an injection motor 350 that causes the screw 330 to advance and retreat, and a load detector 360 that measures a load transmitted between the injection motor 350 and the screw 330.

The cylinder 310 heats the molding material fed from a feed port 311 to the inside. The molding material includes, for example, a resin and the like. The molding material is formed in the shape of, for example, pellets and is fed to the feed port 311 in a solid state. The feed port 311 is formed at a rear portion of the cylinder 310. A cooler 312, such as a water cooling cylinder, is provided on an outer periphery of the rear portion of the cylinder 310. First heating units 313, such as band heaters, and first temperature measurers 314 are provided on the outer periphery of the cylinder 310 in front of the cooler 312.

The cylinder 310 is divided into a plurality of zones in an axial direction of the cylinder 310 (for example, the X-axis direction). The first heating unit 313 and the first temperature measurer 314 are provided in each of the plurality of zones. A set temperature is set in each of the plurality of zones, and the control device 700 controls the first heating units 313 such that temperatures measured by the first temperature measurers 314 reach the set temperatures.

The nozzle 320 is provided at the front end portion of the cylinder 310, and is pressed against the mold unit 800. Second heating units 323 and second temperature measurers 324 are provided on an outer periphery of the nozzle 320. The control device 700 controls the second heating units 323 such that the measured temperature of the nozzle 320 reaches a set temperature.

The screw 330 is disposed in the cylinder 310 to be capable of advancing and retreating and to be rotatable. In a case where the screw 330 is rotated, a molding material is fed forward along a helical groove of the screw 330. The molding material is gradually melted by heat from the cylinder 310 while being fed forward. As the liquid molding material is fed in front of the screw 330 and is accumulated in the front portion of the cylinder 310, the screw 330 is caused to retreat. After that, in a case where the screw 330 is caused to advance, the liquid molding material accumulated in front of the screw 330 is injected from the nozzle 320 and the mold unit 800 is filled with the molding material.

A backflow prevention ring 331 is attached to a front portion of the screw 330 to be capable of advancing and retreating as a backflow prevention valve that prevents backflow of the molding material flowing rearward from the front of the screw 330 in a case where the screw 330 is pushed forward.

In a case where the screw 330 is caused to advance, the backflow prevention ring 331 is pushed rearward by the pressure of the molding material accumulated in front of the screw 330 and retreats relative to the screw 330 up to a close position (see FIG. 2) where the flow channel for a molding material is closed. Accordingly, the molding material accumulated in front of the screw 330 is prevented from flowing back to the rear.

On the other hand, in a case where the screw 330 is rotated, the backflow prevention ring 331 is pushed forward by the pressure of the molding material fed forward along the helical groove of the screw 330 and advances relative to the screw 330 up to an open position (see FIG. 1) where the flow channel for a molding material is opened. Accordingly, the molding material is fed in front of the screw 330.

The backflow prevention ring 331 may be of either a co-rotation type that is rotated together with the screw 330 or a non-co-rotation type that is not rotated together with the screw 330.

The injection unit 300 may include a drive source that causes the backflow prevention ring 331 to advance and retreat with respect to the screw 330 between the open position and the close position.

The plasticizing motor 340 rotates the screw 330. A drive source that rotates the screw 330 is not limited to the plasticizing motor 340, and may be, for example, a hydraulic pump or the like.

The injection motor 350 causes the screw 330 to advance and retreat. A motion conversion mechanism that converts a rotary motion of the injection motor 350 into a linear motion of the screw 330, and the like are provided between the injection motor 350 and the screw 330. The motion conversion mechanism includes, for example, a screw shaft and a screw nut that is screwed to the screw shaft. Balls, rollers, or the like may be provided between the screw shaft and the screw nut. A drive source that causes the screw 330 to advance and retreat is not limited to the injection motor 350, and may be, for example, a hydraulic cylinder or the like.

The load detector 360 measures a load that is transmitted between the injection motor 350 and the screw 330. The measured load is converted into a pressure by the control device 700. The load detector 360 is provided in a transmission channel for a load between the injection motor 350 and the screw 330, and measures a load that acts on the load detector 360.

The load detector 360 sends a signal of the measured load to the control device 700. The load measured by the load detector 360 is converted into a pressure that acts between the screw 330 and the molding material, and is used for the control and monitoring of a pressure that is received by the screw 330 from the molding material, a back pressure that acts on the screw 330, a pressure that acts on the molding material from the screw 330, and the like.

A pressure detector that measures the pressure of the molding material is not limited to the load detector 360, and a general detector can be used. For example, a nozzle pressure sensor or a mold internal pressure sensor may be used. The nozzle pressure sensor is installed in the nozzle 320. The mold internal pressure sensor is installed in the mold unit 800.

The injection unit 300 performs a plasticizing process, a filling process, a holding pressure process, and the like under the control of the control device 700. The filling process and the holding pressure process may also be collectively referred to as an injection process.

In the plasticizing process, the plasticizing motor 340 is driven to rotate the screw 330 at a set rotating speed to feed the molding material forward along the helical groove of the screw 330. Accordingly, the molding material is gradually melted. As the liquid molding material is fed in front of the screw 330 and is accumulated in the front portion of the cylinder 310, the screw 330 is caused to retreat. A rotating speed of the screw 330 is measured using, for example, a plasticizing motor encoder 341. The plasticizing motor encoder 341 measures rotation of the plasticizing motor 340 and sends a signal indicating a detection result thereof to the control device 700. A screw rotating speed detector that measures the rotating speed of the screw 330 is not limited to the plasticizing motor encoder 341, and a general detector can be used.

In the plasticizing process, the injection motor 350 may be driven to apply a set back pressure to the screw 330 to limit the sudden retreat of the screw 330. The back pressure applied to the screw 330 is measured using, for example, the load detector 360. In a case where the screw 330 retreats up to a plasticizing completion position and a predetermined amount of molding material is accumulated in front of the screw 330, the plasticizing process is completed.

Positions and rotating speeds of the screw 330 in the plasticizing process are collectively set as a series of set conditions. For example, a plasticizing start position, a rotating speed switching position, and a plasticizing completion position are set. These positions are arranged in this order from the front side toward the rear, and indicate starting points and end points of sections in which the rotating speeds are set. The rotating speed is set for each section. One rotating speed switching position may be set, or a plurality of rotating speed switching positions may be set. The rotating speed switching position may not be set. Further, a back pressure is set for each section.

In the filling process, the injection motor 350 is driven to cause the screw 330 to advance at a set movement speed and to fill the cavity spaces 801 formed in the mold unit 800 with the liquid molding material accumulated in front of the screw 330. The position and the movement speed of the screw 330 are measured using, for example, an injection motor encoder 351. The injection motor encoder 351 measures rotation of the injection motor 350 and sends a signal indicating a detection result thereof to the control device 700. In a case where the position of the screw 330 reaches a set position, switching of the filling process to the holding pressure process (so-called V/P switching) is performed. A position where V/P switching is performed is also referred to as a V/P switching position. The set movement speed of the screw 330 may be changed depending on the position of the screw 330, a time, or the like.

Positions and movement speeds of the screw 330 in the filling process are collectively set as a series of set conditions. For example, a filling start position (also referred to as an “injection start position”), a movement speed switching position, and a V/P switching position are set. These positions are arranged in this order from the rear side toward the front, and indicate starting points and end points of sections in which the movement speeds are set. The movement speed is set for each section. One movement speed switching position may be set, or a plurality of movement speed switching positions may be set. The movement speed switching position may not be set.

An upper limit of the pressure of the screw 330 is set for each section in which the movement speed of the screw 330 is set. The pressure of the screw 330 is measured by the load detector 360. In a case where the pressure of the screw 330 is equal to or lower than a setting pressure, the screw 330 advances at a set movement speed. On the other hand, in a case where the pressure of the screw 330 exceeds the setting pressure, the screw 330 advances at a movement speed lower than the set movement speed so that the pressure of the screw 330 is equal to or lower than the setting pressure for the purpose of protecting the mold.

After the position of the screw 330 reaches the V/P switching position in the filling process, the screw 330 may be caused to temporarily stop at the V/P switching position, and the V/P switching may be then performed. Immediately before the V/P switching, instead of the screw 330 being stopped, the screw 330 may advance at a very low speed or retreat at a very low speed. Further, a screw position detector for measuring the position of the screw 330 and a screw movement speed detector for measuring the movement speed of the screw 330 are not limited to the injection motor encoder 351, and general detectors can be used.

In the holding pressure process, the injection motor 350 is driven to push the screw 330 forward to maintain the pressure of the molding material at a front end portion of the screw 330 (hereinafter, also referred to as a “holding pressure”) at a setting pressure and to push a molding material remaining in the cylinder 310 toward the mold unit 800. A shortage of the molding material due to cooling shrinkage inside the mold unit 800 can be replenished. The holding pressure is measured using, for example, the load detector 360. A set value of the holding pressure may be changed depending on a time that has passed from the start of the holding pressure process, or the like. A plurality of holding pressures and a plurality of holding times in which the holding pressure is held in the holding pressure process may be set, and may be collectively set as a series of set conditions.

The molding material, with which the cavity spaces 801 formed in the mold unit 800 is filled, is gradually cooled in the holding pressure process, and an inlet of the cavity spaces 801 is closed by the solidified molding material at the time of completion of the holding pressure process. This state is referred to as a gate seal, and the backflow of the molding material from the cavity spaces 801 is prevented. A cooling process is started after the holding pressure process. The molding material in the cavity spaces 801 is solidified in the cooling process. The plasticizing process may be performed in the cooling process for the purpose of shortening a molding cycle time.

The injection unit 300 of the present embodiment is of an in-line screw type, but may be of a pre-plasticizing type or the like. A pre-plasticizing type injection unit feeds a molding material, which is melted in a plasticizing cylinder, to an injection cylinder and injects the molding material into a mold unit from the injection cylinder. A screw is disposed in the plasticizing cylinder to be rotatable and not to be capable of advancing and retreating, or a screw is disposed in the plasticizing cylinder to be rotatable and to be capable of advancing and retreating. Meanwhile, a plunger is disposed in the injection cylinder to be capable of advancing and retreating.

Further, the injection unit 300 of the present embodiment is of a horizontal type in which the axial direction of the cylinder 310 is a horizontal direction, but may be of a vertical type in which the axial direction of the cylinder 310 is a vertical direction. A mold clamping unit to be combined with a vertical type injection unit 300 may be of a vertical type or a horizontal type. Likewise, a mold clamping unit to be combined with a horizontal type injection unit 300 may be of a horizontal type or a vertical type.

### Moving Unit

In the description of the moving unit 400, as in the description of the injection unit 300, the moving direction of the screw 330 during filling (for example, the X-axis negative direction) will correspond to a front, and the moving direction of the screw 330 during plasticizing (for example, the X-axis positive direction) will correspond to a rear.

The moving unit 400 causes the injection unit 300 to advance and retreat with respect to the mold unit 800. Further, the moving unit 400 presses the nozzle 320 against the mold unit 800 to generate a nozzle touch pressure. The moving unit 400 includes a hydraulic pump 410, a motor 420 as a drive source, a hydraulic cylinder 430 as a hydraulic actuator, and the like.

The hydraulic pump 410 includes a first port 411 and a second port 412. The hydraulic pump 410 is a pump that can be rotated in both directions, and sucks hydraulic fluid (for example, oil) from any one of the first port 411 and the second port 412 and discharges the hydraulic fluid from the other thereof to generate hydraulic pressure in a case where a rotation direction of the motor 420 is changed. The hydraulic pump 410 can also suck hydraulic fluid from a tank and discharge the hydraulic fluid from any one of the first port 411 and the second port 412.

The motor 420 causes the hydraulic pump 410 to operate. The motor 420 drives the hydraulic pump 410 in a rotation direction, which corresponds to a control signal sent from the control device 700, with rotation torque corresponding to the control signal. The motor 420 may be an electric motor or may be an electric servomotor.

The hydraulic cylinder 430 includes a cylinder body 431, a piston 432, and a piston rod 433. The cylinder body 431 is fixed to the injection unit 300. The piston 432 partitions the inside of the cylinder body 431 into a front chamber 435 as a first chamber and a rear chamber 436 as a second chamber. The piston rod 433 is fixed to the stationary platen 110.

The front chamber 435 of the hydraulic cylinder 430 is connected to the first port 411 of the hydraulic pump 410 via a first flow channel 401. In a case where hydraulic fluid discharged from the first port 411 is supplied to the front chamber 435 via the first flow channel 401, the injection unit 300 is pushed forward. The injection unit 300 advances, so that the nozzle 320 is pressed against the stationary mold 810. The front chamber 435 functions as a pressure chamber that generates the nozzle touch pressure of the nozzle 320 with the pressure of the hydraulic fluid supplied from the hydraulic pump 410.

On the other hand, the rear chamber 436 of the hydraulic cylinder 430 is connected to the second port 412 of the hydraulic pump 410 via a second flow channel 402. In a case where hydraulic fluid discharged from the second port 412 is supplied to the rear chamber 436 of the hydraulic cylinder 430 via the second flow channel 402, the injection unit 300 is pushed rearward. The injection unit 300 retreats, so that the nozzle 320 is separated from the stationary mold 810.

The moving unit 400 includes the hydraulic cylinder 430 in the present embodiment, but the present invention is not limited thereto. For example, an electric motor and a motion conversion mechanism that converts a rotary motion of the electric motor into a linear motion of the injection unit 300 may be used instead of the hydraulic cylinder 430.

### Control Device

The control device 700 is formed of, for example, a computer and includes a central processing unit (CPU) 701, a storage medium 702, such as a memory, an input interface 703, and an output interface 704 as shown in FIGS. 1 and 2. The control device 700 causes the CPU 701 to execute a program, which is stored in the storage medium 702, to perform various types of control. Further, the control device 700 receives a signal from the outside through the input interface 703, and transmits a signal to the outside through the output interface 704.

The control device 700 repeatedly performs the plasticizing process, the mold closing process, the pressurization process, the mold clamping process, the filling process, the holding pressure process, the cooling process, the depressurization process, the mold opening process, the ejection process, and the like to repeatedly manufacture molding products. A series of operations for obtaining molding products, for example, operations from the start of a plasticizing process to the start of the next plasticizing process, are also referred to as a “shot” or a “molding cycle”. Further, a time required for one shot is also referred to as a “molding cycle time” or a “cycle time”.

One molding cycle includes, for example, the plasticizing process, the mold closing process, the pressurization process, the mold clamping process, the filling process, the holding pressure process, the cooling process, the depressurization process, the mold opening process, and the ejection process in this order. The order mentioned here is an order in which the respective processes are started. The filling process, the holding pressure process, and the cooling process are performed during the mold clamping process. The start of the mold clamping process may coincide with the start of the filling process. The completion of the depressurization process coincides with the start of the mold opening process.

A plurality of processes may be simultaneously performed for the purpose of shortening a molding cycle time. For example, a plasticizing process may be performed during a cooling process of a previous molding cycle, or may be performed during a mold clamping process. In this case, the mold closing process may be performed at the beginning of the molding cycle. Further, the filling process may be started during the mold closing process. Furthermore, the ejection process may be started during the mold opening process. In a case where an on-off valve for opening and closing a flow channel of the nozzle 320 is provided, the mold opening process may be started during the plasticizing process. The reason for this is that a molding material does not leak from the nozzle 320 as long as the on-off valve closes the flow channel of the nozzle 320 even though the mold opening process is started during the plasticizing process.

One molding cycle may include processes other than the plasticizing process, the mold closing process, the pressurization process, the mold clamping process, the filling process, the holding pressure process, the cooling process, the depressurization process, the mold opening process, and the ejection process.

For example, a pre-plasticizing suck-back process for causing the screw 330 to retreat up to a preset plasticizing start position may be performed before the start of the plasticizing process after the completion of the holding pressure process. Since the pressure of the molding material accumulated in front of the screw 330 can be reduced before the start of the plasticizing process, the sudden retreat of the screw 330 at the time of start of the plasticizing process can be prevented.

Further, a post-plasticizing suck-back process for causing the screw 330 to retreat up to a preset filling start position (also referred to as an “injection start position”) may be performed before the start of the filling process after the completion of the plasticizing process. Since the pressure of the molding material accumulated in front of the screw 330 can be reduced before the start of the filling process, leakage of the molding material from the nozzle 320 before the start of the filling process can be prevented.

The control device 700 is connected to an operation unit 750 that receives an input operation performed by a user and to a display unit 760 that displays a screen. The operation unit 750 and the display unit 760 may be formed of, for example, a touch panel 770 and may be integrated with each other. The touch panel 770 as the display unit 760 displays a screen under the control of the control device 700. For example, information, such as the settings of the injection molding machine 10 and the current state of the injection molding machine 10, is displayed on the screen of the touch panel 770. Further, for example, operation parts, such as buttons or input fields used to receive an input operation performed by a user, may be displayed on the screen of the touch panel 770. The touch panel 770 as the operation unit 750 detects an input operation performed on the screen by a user, and outputs a signal corresponding to the input operation to the control device 700. Accordingly, for example, a user can operate the operation part provided on the screen to set the injection molding machine 10 (including the input of a set value) while checking information displayed on the screen. Further, a user can operate the operation part provided on the screen to cause the operation of the injection molding machine 10, which corresponds to the operation part, to be performed. The operation of the injection molding machine 10 may be, for example, the operation (also including stopping) of the mold clamping unit 100, the ejector unit 200, the injection unit 300, the moving unit 400, or the like. Further, the operation of the injection molding machine 10 may be switching of the screen that is displayed on the touch panel 770 as the display unit 760, or the like.

The operation unit 750 and the display unit 760 of the present embodiment have been described as being integrated as the touch panel 770, but may be provided independently of each other. Further, a plurality of operation units 750 may be provided. The operation unit 750 and the display unit 760 are disposed on an operation side (Y-axis negative direction) of the mold clamping unit 100 (more specifically, the stationary platen 110).

### Details of Control Device

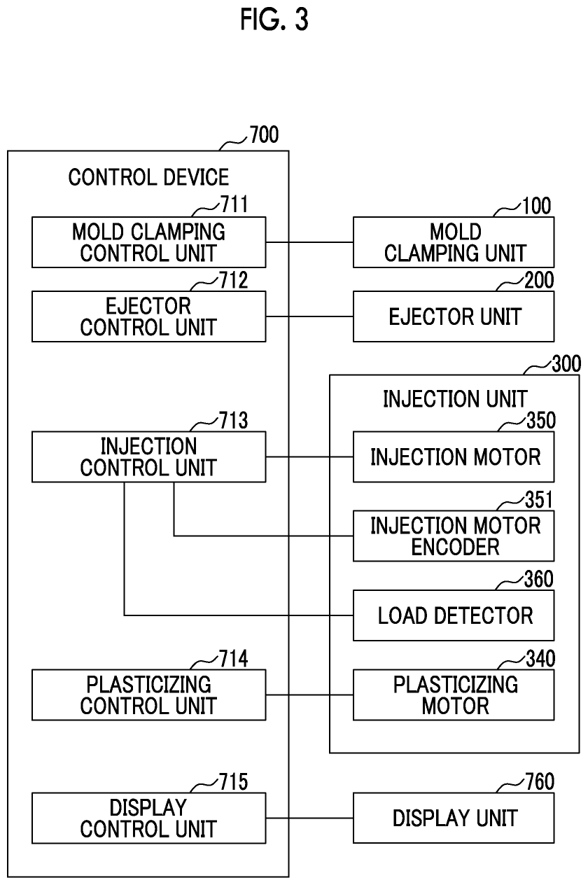

Next, an example of components of the control device 700 will be described with reference to FIG. 3. The respective functional blocks shown in FIG. 3 are conceptual and do not necessarily need to be physically configured as shown. All or a part of the respective functional blocks can be functionally or physically distributed and integrated as any unit. All or any part of each processing function performed by each functional block may be realized by a program executed by a CPU, or may be realized by hardware using a wired logic.

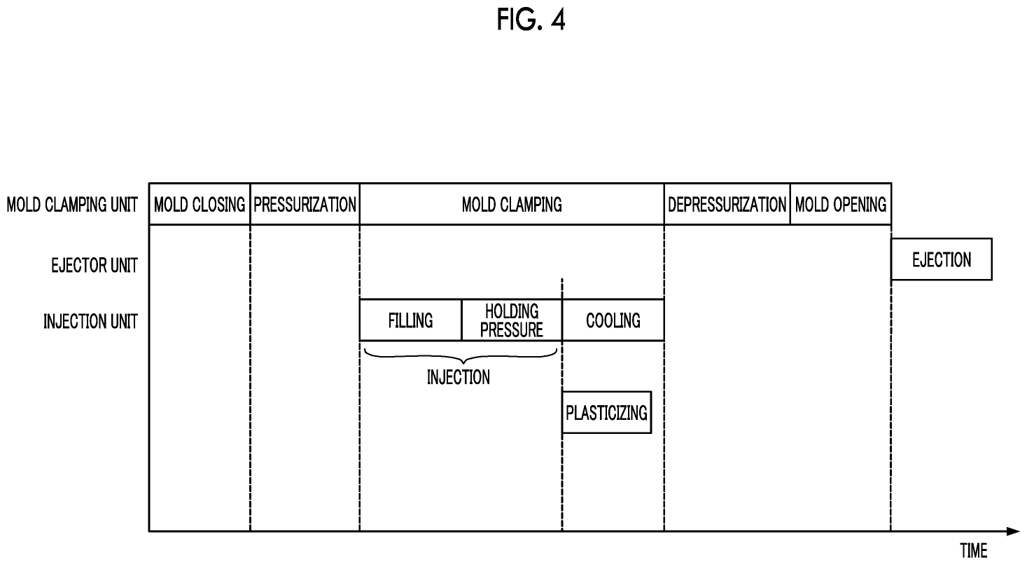

As shown in FIG. 3, the control device 700 includes, for example, a mold clamping control unit 711, an ejector control unit 712, an injection control unit 713, a plasticizing control unit 714, and a display control unit 715. The mold clamping control unit 711 controls the mold clamping unit 100, and performs the mold closing process, the pressurization process, the mold clamping process, the depressurization process, and the mold opening process shown in FIG. 4. The ejector control unit 712 controls the ejector unit 200 and performs the ejection process. The injection control unit 713 controls an injection drive source of the injection unit 300 and performs the injection process. The injection drive source is, for example, the injection motor 350 but may be a hydraulic cylinder or the like. The injection process includes the filling process and the holding pressure process. The injection process is performed during the mold clamping process. The plasticizing control unit 714 controls a plasticizing drive source of the injection unit 300 and performs the plasticizing process. The plasticizing drive source is, for example, the plasticizing motor 340 but may be a hydraulic pump or the like. The plasticizing process is performed during the cooling process. The display control unit 715 controls the display unit 760.

The filling process is a process for controlling the injection drive source such that an actual value of a movement speed of an injection member provided in the cylinder 310 reaches a set value. The filling process is a process for filling the inside of the mold unit 800 with liquid molding material (for example, a resin), which is accumulated in front of the injection member, by moving the injection member forward. The injection member is, for example, the screw 330 but may be a plunger.

The movement speed of the injection member is measured using a speed detector. The speed detector is, for example, the injection motor encoder 351. In a case where the injection member advances in the filling process, a pressure acting on the molding material from the injection member is increased. The filling process may include a process for temporarily stopping the injection member or a process for causing the injection member to retreat, immediately before the holding pressure process.

The holding pressure process is a process for controlling the injection drive source such that an actual value of a pressure acting on the molding material from the injection member reaches a set value. The holding pressure process is a process for replenishing a shortage of molding material due to cooling shrinkage in the mold unit 800 by pushing the injection member forward. The pressure is measured using a pressure detector, such as the load detector 360. A nozzle pressure sensor or a mold internal pressure sensor may be used as the pressure detector.

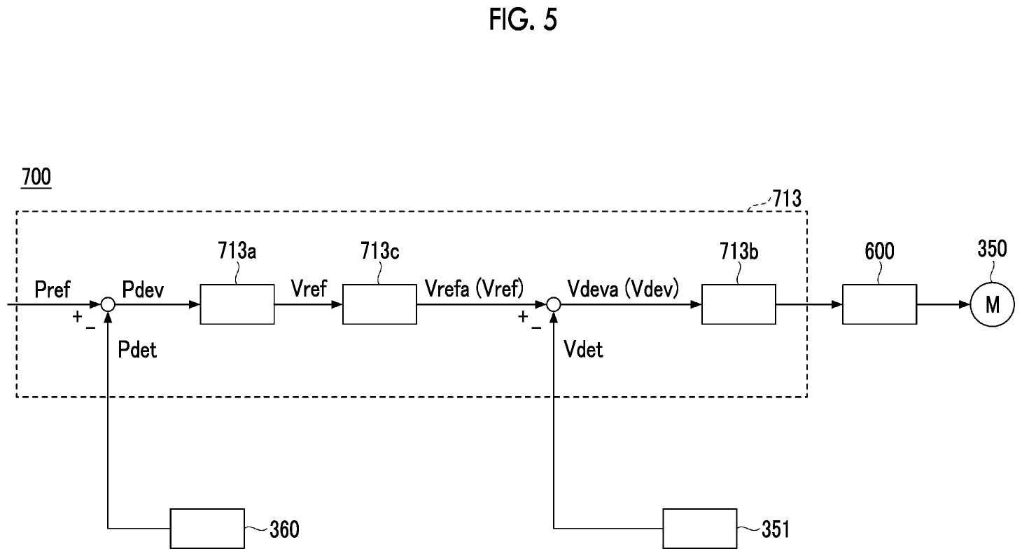

The holding pressure process is controlled by the injection control unit 713. As shown in FIG. 5, the injection control unit 713 includes, for example, a speed command creation part 713a and a voltage command creation part 713b. The speed command creation part 713a creates a speed command value Vref of the screw 330 on the basis of a set pressure value Pref and an actual pressure value Pdet. The voltage command creation part 713b creates a voltage command value for an inverter 600 on the basis of the speed command value Vref and an actual speed value Vdet. The inverter 600 supplies AC to the injection motor 350 according to the voltage command value.

The speed command creation part 713a creates the speed command value Vref such that the actual pressure value Pdet reaches the set pressure value Pref. For example, the speed command creation part 713a creates the speed command value Vref such that an absolute value of a difference Pdev (Pdev=Pref−Pdet) between the actual pressure value Pdet and the set pressure value Pref is reduced (preferably zero). The actual pressure value Pdet is acquired using the pressure detector, such as the load detector 360. For example, PI calculation, PID calculation, or the like is used to create the speed command value Vref.

The voltage command creation part 713b creates a command for the injection drive source such that the actual speed value Vdet reaches the speed command value Vref. For example, the voltage command creation part 713b creates the voltage command value such that an absolute value of a difference Vdev (Vdev=Vref−Vdet) between the speed command value Vref and the actual speed value Vdet is reduced (preferably zero). The actual speed value Vdet is acquired using the speed detector, such as the injection motor encoder 351. For example, PID calculation, PI calculation, or the like is used to create the voltage command value.

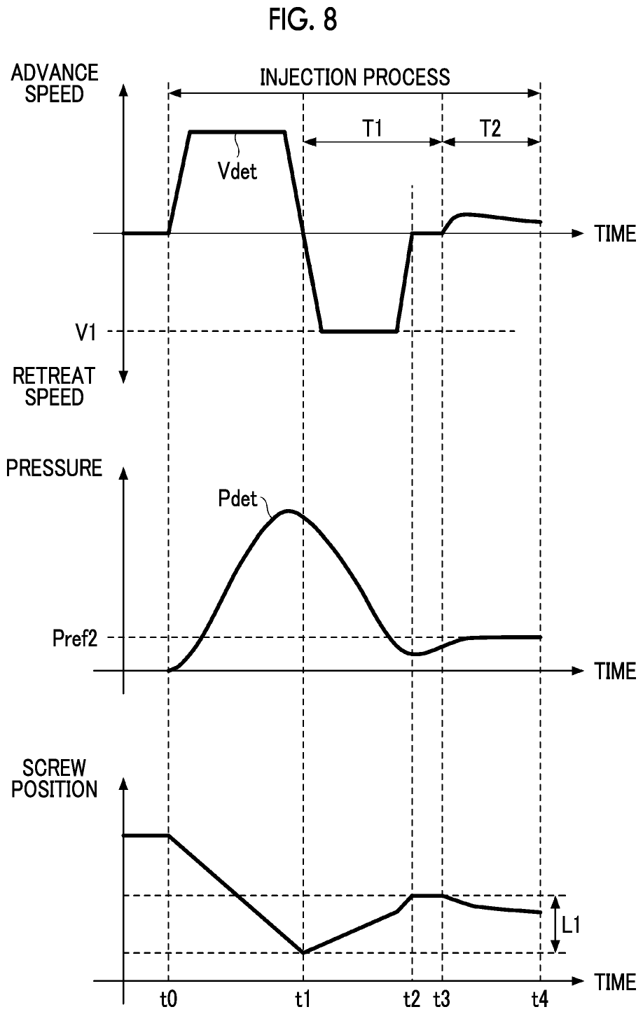

The injection control unit 713 includes a speed command correction part 713c. The speed command correction part 713c selectively performs any one of a retreat speed control and a retreat speed limitation during the retreat of the screw 330 in the injection process. Whether to perform the retreat speed control or the retreat speed limitation is set using a screen 761 (see FIG. 8) to be described later.

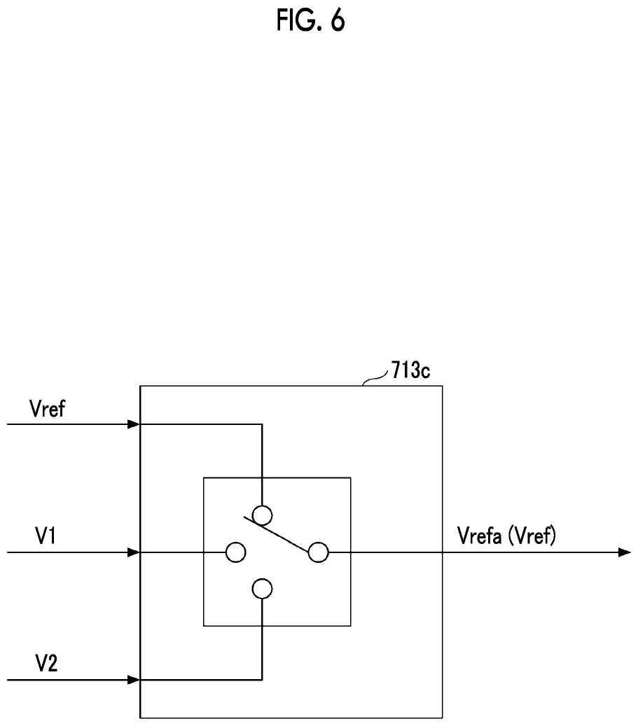

The speed command correction part 713c may not perform any of the retreat speed control and the retreat speed limitation. In this case, the speed command correction part 713c inputs the speed command value Vref, which is created by the speed command creation part 713a, as it is to the voltage command creation part as a second speed command value Vrefa (see FIG. 6).

The retreat speed control controls the actual speed value Vdet of the screw 330 to a first set value V1 (>0) during the retreat of the screw 330. The retreat speed control is a so-called feedback-control. For example, the retreat speed control is performed in a case where the advance speed of the injection member is set high in the filling process, such as a case where the thickness of a molding product is small. In a case where the retreat speed control is performed, a resin pressure can be reduced and the uneven distribution of residual stress can be suppressed. Accordingly, warpage of a molding product can be suppressed.

In a case where the speed command correction part 713c performs the retreat speed control, the speed command correction part 713c inputs the first set value V1 to the voltage command creation part 713b as the second speed command value Vrefa regardless of the speed command value Vref created by the speed command creation part 713a. Accordingly, the actual speed value Vdet reaches the first set value V1 during the retreat of the screw 330.

On the other hand, the retreat speed limitation limits the actual speed value Vdet of the screw 330 to a second set value V2 (>0) or less during the retreat of the screw 330. It is possible to eliminate an adverse effect on the quality of a molding product that is caused in a case where the screw 330 retreats at a high speed immediately after V/P switching. The second set value V2 is set such that an adverse effect on the quality of a molding product caused in a case where the screw 330 retreats at a high speed is eliminated.

In a case where the speed command correction part 713c performs the retreat speed limitation, the speed command correction part 713c compares the speed command value Vref (Vref>0) with the second set value V2 (V2>0) and inputs the minimum value of the values to the voltage command creation part 713b as the second speed command value Vrefa. In a case where Vref and V2 are equal to each other, Vrefa is equal to Vref.

The voltage command creation part 713b creates a second voltage command value on the basis of the second speed command value Vrefa, which is created by the speed command correction part 713c, and the actual speed value Vdet. The voltage command creation part 713b creates the second voltage command value such that an absolute value of a difference Vdeva (Vdeva=Vrefa−Vdet) between the second speed command value Vrefa and the actual speed value Vdet is reduced (preferably zero). The inverter 600 supplies AC to the injection motor 350 according to the second voltage command value. Accordingly, any one of the retreat speed control and the retreat speed limitation can be selectively performed.

The injection control unit 713 may temporarily stop the screw 330 immediately before selectively performing any one of the retreat speed control and the retreat speed limitation.

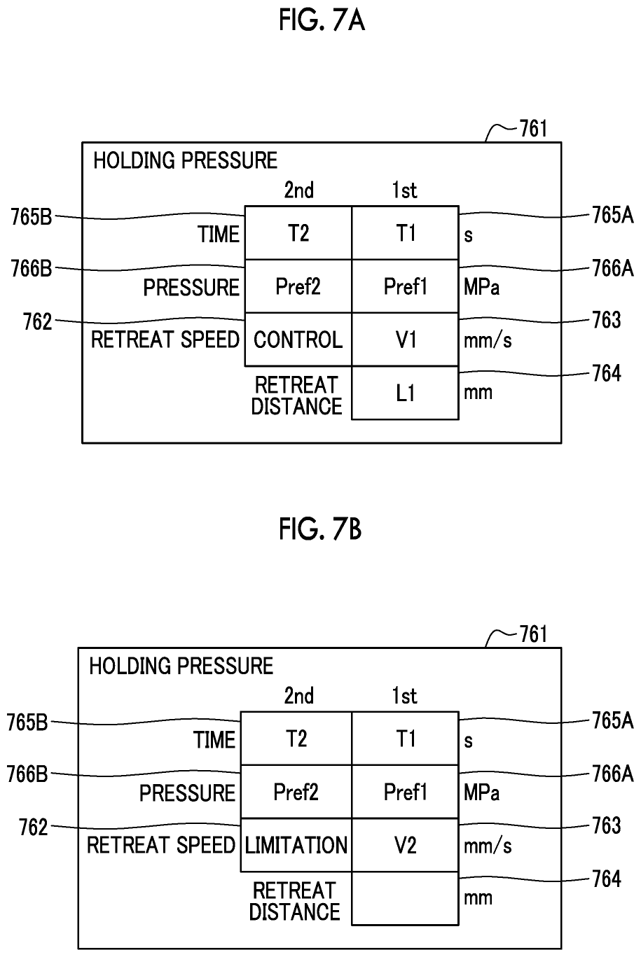

Next, an example of a screen 761 used to select the retreat speed control and the retreat speed limitation will be described with reference to FIGS. 7A and 7B. The screen 761 includes, for example, a selection part 762 that receives a selection of whether to perform the retreat speed control or the retreat speed limitation. The selection part 762 may receive a selection in which none of the retreat speed control and the retreat speed limitation are performed.

The selection part 762 displays a plurality of candidates according to a user's input operation. The plurality of candidates are displayed using, for example, a pull-down menu. Examples of the plurality of candidates include “control”, “limitation”, and “off”. The selection part 762 displays one candidate (setting) that is selected from the plurality of candidates by a user.

In a case where the selection part 762 displays “control”, the speed command correction part 713c performs the retreat speed control. On the other hand, in a case where the selection part 762 displays “limitation”, the speed command correction part 713c performs the retreat speed limitation. In a case where the selection part 762 displays “off”, the speed command correction part 713c does not perform any of the retreat speed control and the retreat speed limitation.

As the plurality of candidates, only “control” and “limitation” may be used, and “off” may not be used. In this case, when numerical values are not input to any of a first input field and a second input field to be described later (in a case where a numerical value is not input to a dual-purpose input field 763 in the present embodiment), the speed command correction part 713c does not perform any of the retreat speed control and the retreat speed limitation.

According to the present embodiment, since the screen 761 including the selection part 762 is displayed, the setting of the injection process can be switched depending on a molding product. The injection control unit 713 controls the injection motor 350 according to the setting made using the screen 761. The retreat speed control and the retreat speed limitation can be selectively performed depending on a molding product.

The screen 761 includes a dual-purpose input field 763 that serves as both a first input field to which the first set value V1 is to be input and a second input field to which the second set value V2 is to be input. Since the first input field and the second input field are integrated as one dual-purpose input field 763, the display of the screen can be simplified as compared to a case where the first input field and the second input field are provided separately.

A user inputs a numerical value to the dual-purpose input field 763 with a numeric keypad or the like while looking at the screen 761. The dual-purpose input field 763 displays the numerical value that is input by the user.

The selection part 762 and the dual-purpose input field 763 are arranged side by side. The selection part 762 and the dual-purpose input field 763 are horizontally or vertically (horizontally in FIGS. 7A and 7B) adjacent to each other. Since the selection part 762 and the dual-purpose input field 763 are arranged side by side, it is easy to determine whether the numerical value input to the dual-purpose input field 763 is the first set value V1 or the second set value V2.

In a case where the selection part 762 displays “control”, the speed command correction part 713c uses the numerical value input to the dual-purpose input field 763 as the first set value V1. On the other hand, in a case where the selection part 762 displays “limitation”, the speed command correction part 713c uses the numerical value input to the dual-purpose input field 763 as the second set value V2.

The screen 761 includes a retreat distance input field 764 to which a set value L1 of a retreat distance of the screw 330 is to be input as a condition in which the retreat speed control is released. In a case where the retreat distance of the screw 330 reaches the set value L1, the retreat speed control is released. Then, a pressure control is performed. The retreat speed control can be shifted to the pressure control, and a constant pressure can be applied to the molding material until the end of the injection process.

A user inputs a numerical value to the retreat distance input field 764 with a numeric keypad or the like while looking at the screen 761. The retreat distance input field 764 displays the numerical value that is input by the user.

The first input field (the dual-purpose input field 763 in the present embodiment) and the retreat distance input field 764 are arranged side by side. The retreat distance input field 764 and the first input field are horizontally or vertically (vertically in FIGS. 7A and 7B) adjacent to each other. Since the retreat distance input field 764 and the first input field are arranged side by side, it is easy to calculate a time when the retreat speed control is to be performed. The time when the retreat speed control is to be performed is substantially equal to L1/V1.

The screen 761 may include input fields 765A, 765B, 766A, and 766B to which set values of the holding pressure process are to be input. In a case where the holding pressure process is divided into n (n is an integer equal to or larger than 2) processes, the k-th (k is an integer equal to or larger than 1 and equal to or smaller than n) process from the filling process is referred to as a k-th stage process. The number of divided processes is 2 in FIGS. 7A and 7B, but may be 3 or more.

The input fields 765A and 766A are fields to which set values T1 and Pref1 of a first stage process are to be input. T1 is a time when the first stage process is to be performed, and Pref1 is a set pressure value in the first stage process. The input fields 765B and 766B are fields to which set values T2 and Pref2 of a second stage process are to be input. T2 is a time when the second stage process is to be performed, and Pref2 is a set pressure value in the second stage process.

The retreat speed control is performed instead of the first stage process of the holding pressure process. For this reason, it is preferable that the first input field (for example, the dual-purpose input field 763) and the input fields 765A, 765B, 766A, and 766B are arranged side by side on the screen 761. It is easy to see that the retreat speed control is performed instead of the first stage process of the holding pressure process.

It is preferable that the input fields 765A and 766A to which the set values of the first stage process are to be input, the first input field (the dual-purpose input field 763 in the present embodiment), and the retreat distance input field 764 are arranged side by side in a line. For example, these input fields are vertically arranged side by side.

Although described in detail later, the input field 765A serves as both an input field to which the set value T1 of a time when the first stage process of the holding pressure process is to be performed is to be input and an input field to which the set value T1 of a time when the retreat speed control is to be performed is to be input.

Next, an example of changes in screw speed, pressure, and screw position with time in a case where the retreat speed control is selected will be described with reference to FIG. 8. Since it is disclosed in the related art, an example of changes in screw speed, pressure, and screw position with time in a case where the retreat speed limitation is selected will not be shown.

In FIG. 8, the screw position is represented by a distance from an advance limit position. As the screw position retreats from the advance limit position, a distance representing the screw position is increased. The advance limit position is determined, for example, depending on the stroke of a ball screw that converts a rotary motion of the injection motor 350 into a linear motion of the screw 330, or the like.

Further, in FIG. 8, to represents a start time of the injection process, t1 represents a start time of the retreat speed control, t2 represents a time when the retreat distance of the screw 330 has reached the set value L1, t3 represents a time when a time having passed from the start of the retreat speed control has reached the set value T1, and t4 represents an end time of the injection process. In addition, t1 corresponds to a time of V/P switching.

In a case where the filling process is started at the time to, the screw position advances at a set speed. As a result, a pressure rises. After that, in a case where the screw position reaches a retreat speed control start position at the time t1, the retreat speed control is started. The retreat speed control controls the injection motor 350 such that the actual speed value Vdet reaches the first set value V1. The actual pressure value Pdet can be rapidly reduced by the retreat speed control.

The retreat speed control is performed until the time t2 when the retreat distance of the screw 330 reaches the set value L1. The screw 330 is temporarily stopped from the time t2 to the time t3, so that the actual speed value Vdet reaches zero. The second stage process of the holding pressure process is performed from the time t3, so that the actual pressure value Pdet reaches the set pressure value Pref2.

The retreat distance of the screw 330 reaches the set value L1 before the time t3 in the present embodiment, but the retreat distance of the screw 330 may not reach the set value L1 at the time t3. In this case, the retreat speed control is released at the time t3 and the second stage process of the holding pressure process is performed.

That is, in a case where a time having passed from the time t1 reaches the set value T1 even though a retreat distance from the time t1 does not reach the set value L1, the retreat speed control is released and the second stage process of the holding pressure process is performed.

The control device of the injection molding machine, the injection molding machine, and a control method for the injection molding machine according to the embodiments of the present invention have been described above, but the present invention is not limited to the above-mentioned embodiments and the like. Various modifications, corrections, substitutions, additions, deletions, and combinations can be made within the scope of the appended claims. Naturally, those also belong to the technical scope of the present invention.

It should be understood that the invention is not limited to the above-described embodiment, but may be modified into various forms on the basis of the spirit of the invention. Additionally, the modifications are included in the scope of the invention.

What is claimed is:

1. A display unit of an injection molding machine including an injection member that is provided in a cylinder heating a molding material and an injection drive source that causes the injection member to advance to fill an inside of a mold unit with the molding material,
wherein a screen including a selection part, which receives a selection of whether to perform a retreat speed control to control an actual speed value of the injection member to a first set value or a retreat speed limitation to limit the actual speed value of the injection member to a second set value or less during a retreat of the injection member, is displayed in an injection process for controlling a speed of the injection member or a pressure acting on the molding material from the injection member.

2. The display unit of an injection molding machine according to claim 1,
wherein the screen includes a dual-purpose input field that serves as both a first input field to which the first set value is to be input and a second input field to which the second set value is to be input.

3. The display unit of an injection molding machine according to claim 2,
wherein the selection part and the dual-purpose input field are arranged side by side.

4. The display unit of an injection molding machine according to claim 1,
wherein the screen includes a retreat distance input field to which a set value of a retreat distance of the injection member is to be input as a condition in which the retreat speed control is released.

5. The display unit of an injection molding machine according to claim 1,
wherein the injection process includes a holding pressure process that controls a pressure acting on the molding material from the injection member, and
a first input field to which the first set value is to be input and an input field to which a set value of the holding pressure process is to be input are arranged side by side on the screen.

6. The display unit of an injection molding machine according to claim 5,
wherein the injection process includes a filling process for controlling a speed of the injection member and the holding pressure process in this order, and
in a case where the holding pressure process is divided into n (n is an integer equal to or larger than 2) processes and a k-th (k is an integer equal to or larger than 1 and equal to or smaller than n) process from the filling process is referred to as a k-th stage process, the screen includes an input field that serves as both an input field to which a set value of a time when a first stage process of the holding pressure process is to be performed is to be input and an input field to which a set value of a time when the retreat speed control is to be performed is to be input.

7. A control device of an injection molding machine that controls the injection process according to a setting made using the display unit according to claim 1.

8. An injection molding machine comprising:
the display unit according to claim 1;
the injection member; and
the injection drive source.
